(19) United States
(12) Patent Application Publication
(10) Pub. No.: US 2006/0243299 A1
(43) Pub. Date: Nov. 2, 2006

(54) Scissor-Like Flossing Device

(76) Inventor: Ricky L. Andrews, Salt Lake City, UT (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/456,798

(22) Filed: Jul. 11, 2006

Related U.S. Application Data
(62) Division of application No. 10/317,422, filed on Dec. 12, 2002, now abandoned.

(51) Int. Cl. A61C 15/00

(52) U.S. Cl. 132/326

(57) ABSTRACT

The present invention is A flossing device having a double-pronged body, a handle, a piece of floss, a feeding spool, a collecting spool, and a means for advancing the floss. A user flosses using a portion of the floss that is disposed in between the two prongs; the user advances the floss by manipulating the handle. Once the user is finished flossing, the user may close the handle so that the prongs close together. When the prongs are closed together, the flossing device may be conveniently stored in the cavity of, for example, a toothbrush holder by placing the closed prongs inside the cavity.

### CROSS-REFERENCES TO RELATED APPLICATIONS

The present application is a claims priority as a divisional of prior Utility application Ser. No. 10/317,422, filed Dec. 12, 2002.

### FIELD OF THE INVENTION

The present invention relates generally to devices and methods for flossing teeth. More particularly, the present invention relates to flossing devices having a handle and floss spools that dispense and collect floss when the handle is manipulated.

### BACKGROUND OF THE INVENTION

There are several flossing devices known in the art. Among these, for example, are the well-known fork-like flossing devices which have two prongs between which floss is manually threaded. A person grasps the handle of the fork-like device and proceeds to floss his or her teeth using the portion of the floss that is threaded between the two prongs. When the floss is ready to be discarded, the user manually removes the floss and throws it away. In order to again use the fork-like device for flossing, the user then re-threads the fork-like device with new floss. Such flossing devices require significant manual manipulation and thus are not particularly convenient to use.

### SUMMARY OF THE INVENTION

The present invention can generally be characterized as a flossing device having a double-pronged body, a handle, a piece of floss, a feeding spool, a collecting spool, and a means for advancing the floss. A user flosses using a portion of the floss that is disposed in between the two prongs; the user advances the floss by manipulating the handle. Once the user is finished flossing, the user may close the handle so that the prongs close together. When the prongs are closed together, the flossing device may be conveniently stored in the cavity of, for example, a toothbrush holder by placing the closed prongs inside the cavity. In the preferred embodiments of the present invention, the body of the flossing device is scissor-shaped, the spools are substantially cylindrical, and the means for advancing the floss involves a ratchet system.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a plan view of one embodiment of the present invention, in a closed position.

FIG. 1B is a plan view of one embodiment of the present invention, in an open position.

FIG. 2A is a plan view of one embodiment of the present invention.

FIG. 2B is an enlarged perspective view of a spool according to one embodiment of the present invention.

FIG. 3A is a plan view of yet another embodiment of the present invention.

FIG. 3B is an enlarged perspective view of a portion of the flossing body according to one embodiment of the present invention.

### DETAILED DESCRIPTION OF THE PREFERRED EMBODIMENT

With reference now to the drawings, the preferred embodiment of the flossing device is herein described. It should be noted that the articles “a”, “an” and “the”, as used in this specification, include plural referents unless the content clearly dictates otherwise.

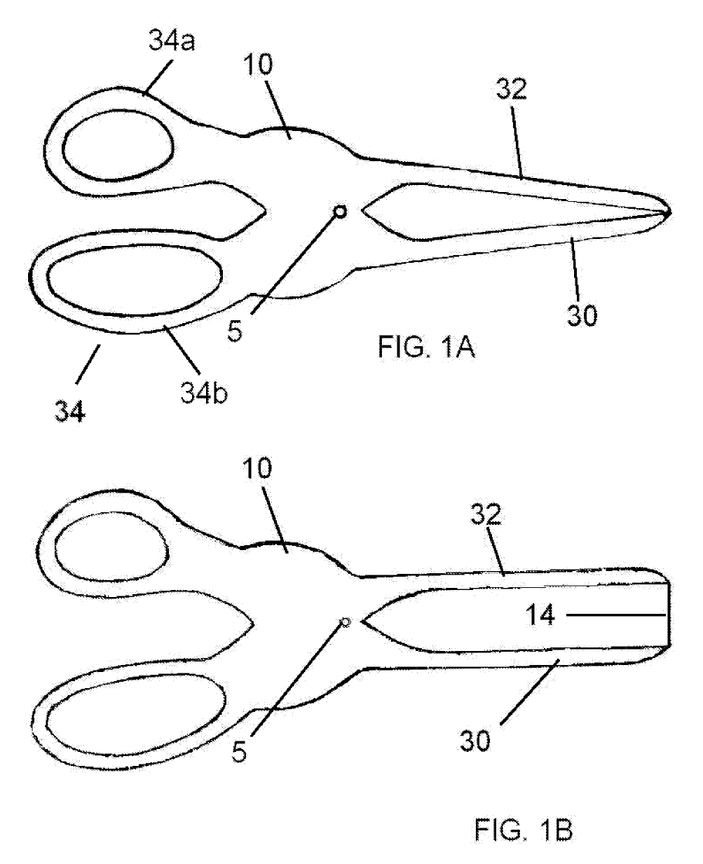

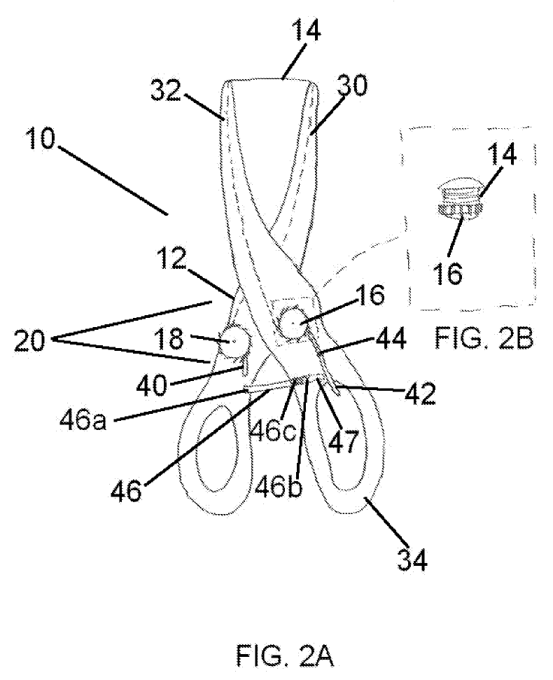

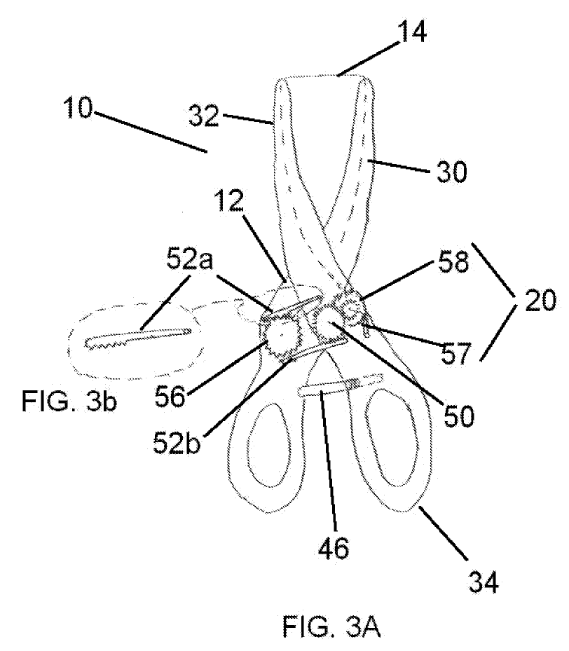

FIG. 1A shows a plan view of a flossing device 10. In this embodiment of the present invention, the flossing device 10 includes a flossing body 12 and a piece of floss 14. Inside the flossing body 12, are a feeding spool 16 having one end of the floss 14 coupled to it, a collecting spool 18 having the other end of the floss 14 coupled to it, and a ratchet system 20 that serves to help advance the floss 14, shown in FIGS. 2A and 3A. The body 12 has a first prong 30, a second prong 32, and a handle 34. The handle 34 has at least two projections 34a and 34b and is designed to be grasped by a single hand of a person or user. The handle 34 can be designed for use by a left-handed person, a right-handed person, or for both. In the preferred embodiments of the present invention, the body 12 is scissor-shaped; in other words, the projections 34a and 34b of the handle 34 comprise two loops that accommodate the fingers of the user's hand, the first and second prongs 30 and 32 are elongated, and the prongs 30 and 32 are movable in relation to each other, pivoting about joint 5, between an open and closed position when the user opens and closes his or her hand as if he or she were using a traditional pair of scissors. In some embodiments, the prongs 30 and 32 may have blunted ends so that the flossing device 10 is appropriate for use by a child. Both the feeding spool 16 and the collecting spool 18 may be coupled to the body 12 of the flossing device 10 in any type of manner. For example, the spools 16 and 18 may be manufactured so as to snap on top of a rod (not shown) extending from the body 12. A cap of any shape may then be placed over the rod to ensure that the spools 16 and 18 remain coupled to the body 12. In some embodiments, either or both of the spools 16 and 18 sit completely exteriorally on top of the body 12; in other embodiments, either or both of the spools 16 and 18 sit partially or completely inside the body 12 (for example, in a cavity in the body 12). The spools 16 and 18 need not be coupled to the same side of the body 12. Moreover, spools 16 and 18 can be of any shape and include any sort of device that can collect the floss 14 into a small amount of space relative to the body 12. However, the preferred shape for the spools is a generally cylindrical shape, as shown in FIG. 2B. The cylindrical spools are preferably rotatable, relative to the body 12, around their central axis. In some embodiments, the feeding spool 16 is a removable spool, and/or the collecting spool 18 is a removable spool that may be disposed of once it has collected an amount of used floss 14. In other embodiments, the feeding spool 16 and/or the collecting spool 18 are fixedly attached to the flossing device 10.

To use the flossing device 10, a feeding spool 16 with fresh floss 14 is coupled to the body 12. Floss 14 from the feeding spool 16 is then threaded through each of the prongs 30 and 32 so that a portion of the floss 14 is disposed in between the two prongs 30 and 32. An end of the floss 14 is then coupled to the collecting spool 18. In the preferred embodiments, the fresh floss 14 is wound around the cylindrical wall of the cylindrical feeding spool 16. The feeding spool 16 might be pre-wound with floss 14 or might be designed so that the user fills the feeding spool 16 by manually winding the floss 14 around the feeding spool 16.

In the preferred embodiments of the present invention, the floss 14 is threaded along as well as inside of the prongs 30 and 32. In other embodiments, the floss 14 is threaded so that it is substantially exterior of the prongs 30 and 32. In some embodiments such as those shown in FIGS. 2A and 3A, the floss 14 extending between the two spools 16 and 18 crosses itself, though such crossing is not necessarily needed in all embodiments. Once the flossing device 10 is threaded with floss 14, the user grasps the handle 34 and flosses using the portion of the floss 14 that is disposed in between the two prongs 30 and 32. With respect to some embodiments such as that shown in FIGS. 1A and 1B, when the user is done with that portion of the floss 14 and while still grasping the handle 34, the user closes his or her hand, causing the projections 34a and 34b of the handle 34 to close towards each other and the prongs 30 and 32 to close towards each other as well, shown in FIG. 1A (in the preferred embodiments, the handle 34 is scissor-shaped, and the user closes the handle 34 and prongs 30 and 32 in the same manner as he or she would a typical pair of scissors). This closing motion, in turn, creates slack in the portion of the floss 14 that is located between the two spools 16 and 18. The user then uses his or her finger or thumb to rotate the collecting spool 18 and take up the slack in the floss 14. Once the slack is removed (or at least reduced), the user opens his or her hand (FIG. 1B), causing the projections 34a and 34b of the handle 34 to open or draw away from each other; the prongs 30 and 32 likewise open away from each other. This opening motion, in turn, causes the collecting spool 18 to draw out fresh floss 14 from the feeding spool 16 because the collecting spool 18 is designed so that it will not move in such a way as to dispense floss 14 from itself: as is true to its namesake, the collecting spool 18 will only collect floss.

In the preferred embodiments, the spools 16 and 18 are substantially cylindrical, and the collecting spool 18 is prevented from rotating in the wrong direction (that is, in a direction that causes the collecting spool 18 to dispense floss 14) via ratchet system 20. The ratchet system 20 comprises at least one rotatable device having teeth that mate with a corresponding projection so that the ratchet system 20 effectively prevents the collecting spool 18 from rotating in the wrong direction. The ratchet system 20 can be coupled to the body 12 or to one or more of the spools 16 and 18 in any way; part or all of it can also be integrally molded with any of the parts of the flossing device 10. Moreover, part or all of the ratchet system 20 can be located exteriorally, interiorally, or partially interiorally of the body 12.

In sum, the combination of the ratchet system 20 and the user's operation of the handle 34 causes the floss 14 to advance. Other means for advancing the floss 14 may also be used, including those to be discussed further herein. Once the user is finished flossing, the user may close the handle 34 so that the prongs 30 and 32 arc situated close to each other. In this configuration, the flossing device 10 may be conveniently stored in the cavity of, for example, a toothbrush holder by placing the closed prongs 30 and 32 inside the cavity. In some embodiments, the user may tear off used floss 14 against a part on the body 12.

FIG. 2A shows another embodiment of a flossing device 10. In this embodiment, both the feeding spool 16 and the collecting spool 18 of this ratchet system 20 have spoke-like teeth located on the circumferences of the spools 16 and 18. As shown in FIG. 2B, the teeth on the spool can be located at the bottom end of the spool. The ratchet system 20 in FIG. 2A further includes a spool locking rod 40 and a spool locking pivot rod or lever 42. One end of the spool locking rod 40 is fixed to the body 12, and the other end of the spool locking rod 40 is disposed between the teeth on the collecting spool 18 so as to allow the collecting spool 18 to rotate in only one direction (that is, the direction that causes the collecting spool 18 to collect floss 14). As for the spool locking pivot lever 42, the latter is similarly disposed between the teeth of the feeding spool 16. However, the pivot lever 42 can pivot about a pivot point 44 so that the pivot lever 42 is no longer disposed between the teeth of the feeding spool 16. While the shape of the teeth are herein described as “spoke-like” and relative positions are described, such descriptions are merely examples as it is easy to conceive of varying types of interfacing teeth and ratcheting systems that would still be considered as being within the purview of this invention.

To operate the embodiment shown in FIG. 2A, the user releases the feeding spool 16 by actuating the pivot lever 42 so that the pivot lever 42 does not mate with the teeth of the feeding spool 16. The user then manipulates the handle 34 so that the prongs 30 and 32 open away from each other, thereby causing the collecting spool 18 (which is prevented from rotating in the wrong direction via the locking rod 40) to draw fresh floss 14 out of the feeding spool 16. In some embodiments of the present invention, a handle locking rod 46 is coupled to the body 12 so that the user may floss without having to worry about accidentally moving the handle 34 in such a way that causes the prongs 30 and 32 to close towards each other. The handle locking rod 46 may be any sort of locking device. For example, the handle locking rod 46 may be like those that are sometimes found on a pair of regular cutting scissors. Such a handle locking rod 46 might comprise a first end 46a that is fixedly attached to one part of the body 12 and a second end 46b that is inserted into a hole 47 in another part of the body 12. The second end 46b might have ridges 46c extending from it to provide friction against the hole 47 when the handle 34 is open. To close the handle 34, the user quickly slightly further opens the handle 34, thereby bypassing the friction from the ridges 46c and allowing the handle 34 to be closed. Once the prongs 30 and 32 are in open position, the user may release the pivot lever 42 so that the pivot lever 42 again engages the teeth on the feeding spool 16. The user may then proceed to floss. When the user desires to advance the floss 14 to use fresh floss, the user can use his or her finger or thumb to rotate the collecting spool 18 (as shown in FIG. 2A, the teeth on the collecting spool 18 preferably extend outside the body 12 so that the user may conveniently access the teeth with his or her thumb) and thereby advance floss 14 from the feeding spool 16. Once the user is finished flossing, the user may manipulate the 20 handle 34 to close together the prongs 30 and 32. Thereafter, the user may desire to further rotate the collecting spool 18 to tighten up any slack in the floss that may have resulted from closing together the prongs 30 and 32.

FIG. 3A shows an embodiment of a flossing device 10 that is designed to be “fully automatic.” Besides two floss spools 56 and 58, the ratchet system 20 of this embodiment includes a ratio gear 50, teethed rods 52a (shown best in FIG. 3B) and 52b, and a rotatable disc 54 coupled to spool 58 to create a centrifugal clutch system. When a user opens the handle 34, the teeth on rod 52a mate with the teeth on spool 56, thereby causing floss 14 to be advanced from spool 56. The opening of the handle 34 also causes rod 52b to actuate rotatable disc 54 via rod 52b and the ratio gear 50. However, spool 58 remains fixed because a rod 57 prevents spool 58 from rotating. Once the handle 34 is opened, the ratchet system 20 becomes locked up so that floss 14 is prevented from advancing from either of the spools 56 or 58. The user may now floss using the flossing device 10. After the user finishes flossing, the user then closes the handle 34. This causes rods 52a and 52b to rotate spool 56 and gear 50, respectively. Gear 50 then actuates the centrifugal clutch system of disc 54 and spool 58 so that the floss 14 from spool 58 is advanced.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. An apparatus comprising:
a. a body having a first prong and a second prong being in a pivoting relationship, thereby being able to move in relation to each other between an open and closed position, and a handle;
b. a continuous piece of floss having a first end, a second end, and a middle portion, said middle portion being strung between said first and second prongs;
c. a feeding spool coupled to said first end of said floss, said feeding spool also being coupled to said body;
d. a collecting spool coupled to said second end of said floss, said collecting spool also being coupled to said body; and
e. a means for advancing said floss between said first and second prongs when said handle is manipulated.

2. The apparatus of claim 1 wherein said handle comprises at least two projections that are movable in relation to each other between an open and closed position.

3. The apparatus of claim 2 wherein said projections comprise two loops designed to accommodate the fingers of a person's hand.

4. The apparatus of claim 1 wherein said body is scissor-shaped.

5. The apparatus of claim 1 wherein said floss is threaded substantially along and substantially inside the part of said body comprising said first and second prongs.

6. The apparatus of claim 1 wherein said means for advancing said floss comprises a ratchet system.

7. The apparatus of claim 6 further comprising a handle locking rod.

8. The apparatus of claim 6 wherein said ratchet system comprises a spool locking rod for locking said collecting spool so that said collecting spool is prevented from feeding said floss and a spool locking lever for selectively locking said feeding spool.

9. The apparatus of claim 6 wherein said means for advancing said floss comprises a teethed rod and a ratio gear coupled to said teethed rod as well as to teeth on one of said spools.

10. An apparatus comprising:
a. a flossing body having a double-looped handle for accommodating the fingers of a person's hand, said flossing body having a first prong and a second prong, said prongs being movable in relation to each other between an open and a closed position via said handle;
b. a piece of floss having a first end, a second end, and a middle portion, said middle portion being strung between said first and second prongs;
c. a rotatable feeding spool around which said first end of said floss is wound, said feeding spool being coupled to said flossing body;
d. a rotatable collecting spool around which said second end of said floss is wound, said collecting spool being coupled to said flossing body;
e. teeth on at least one of said spools; and
f. a means for catching against said teeth, said means being coupled to said flossing body.

11. The apparatus of claim 10 wherein said handle and said prongs open simultaneously.

12. The apparatus of claim 10 wherein said means for catching against said teeth comprises a rod coupled to said body.

13. The apparatus of claim 10 further comprising a spool locking rod for locking said collecting spool so that said collecting spool is prevented from rotating in a wrong direction and a spool locking lever for selectively locking said feeding spool.

14. The apparatus of claim 10 further comprising a centrifugal clutch system coupled to said body for advancing said floss.

15. A method comprising:
a. coupling a first rotatable spool of floss to a scissor-shaped body;
b. threading a portion of the floss from the first spool of floss so that said portion of floss is threaded in between a first prong and a second prong on said scissor-shaped body;
c. coupling an end of the floss to a second rotatable spool;
d. coupling said second spool to said scissor-shaped body; and
e. coupling a rod to one of said spools for controlling the rotation of said one of said spools.

16. The method of claim 15 further comprising coupling a pivotable spool locking lever to said body for selectively locking one of said spools.

17. The method of claim 15 further comprising coupling a centrifugal clutch system to said body for controlling the advancement of said floss.

18. The method of claim 15 wherein said step of threading comprises threading said floss along and inside the part of said body comprising said prongs.
